(19) United States
(12) Patent Application Publication
(10) Pub. No.: US 2019/0279056 A1
(43) Pub. Date: Sep. 12, 2019

(54) IMAGE PROCESSING APPARATUS, IMAGE FORMING APPARATUS, AND NON-TRANSITORY COMPUTER READABLE MEDIUM STORING PROGRAM

(71) Applicant: FUJI XEROX CO.,LTD., Tokyo (JP)

(72) Inventors: Daiki TAKAZAWA, Kanagawa (JP); Tomoyuki ONO, Kanagawa (JP); Masaki NUDEJIMA, Kanagawa (JP); Takayuki HASHIMOTO, Kanagawa (JP); Suguru OUE, Kanagawa (JP)

(73) Assignee: FUJI XEROX CO.,LTD., Tokyo (JP)

(21) Appl. No.: 16/211,184

(22) Filed: Dec. 5, 2018

(30) Foreign Application Priority Data
Mar. 8, 2018 (JP) 2018-041948

(51) Int. Cl. G06K 15/02

(52) U.S. Cl. CPC G06K 15/1826; G06T 7/13; G06K 15/1822

(57) ABSTRACT

An image processing apparatus includes a trapping section that performs trapping on a received pixel, a digital filtering section that performs digital filtering on the pixel in parallel with the trapping using the trapping section, and a selection section that selects a result of the trapping using the trapping section and a result of the digital filtering using the digital filtering section.

### CROSS-REFERENCE TO RELATED APPLICATIONS

This application is based on and claims priority under 35 USC 119 from Japanese Patent Application No. 2018-041948 filed Mar. 8, 2018.

### BACKGROUND

### (i) Technical Field

The present invention relates to an image processing apparatus, an image forming apparatus, and a non-transitory computer readable medium storing a program.

### (ii) Related Art

JP2004-171099A discloses an image data processing apparatus that includes an input section that inputs data items, a storage section that stores the input data items, an image processing unit that performs window processing on the data items, and a control unit that controls the storing order of the data items within the storage section. In a case where the window processing is performed on the data items multiple times, the control unit alternately stores the data items to be processed whenever the window processing is performed in the storage section before the window processing is performed.

JP2005-064639A discloses an image processing apparatus that includes a delay section that delays input image data, a first image data path through which the image data delayed by the delay section passes, and a second image data path which is provided in parallel with the first image data path and through which the image data delayed by the delay section passes. The data delay different from the data delay on the second image data path is caused on the first image data path, and the delay section outputs the image data items with different delay amounts on the first image data path and the second image data path.

JP1995-212579A discloses an image processing apparatus that processes an image constituted by plural pixels each having density data. The image processing apparatus includes a region determination section that determines which of a text region, a halftone region, and a dot region a processing target pixel belongs to, a first processing section that performs first processing corresponding to the text region on the density data of the processing target pixel in parallel with the determination using the region determination section, a second processing section that performs second processing corresponding to the halftone region on the density data of the processing target pixel in parallel with the determination using the region determination section, a third processing section that performs third processing corresponding to the dot region on the density data of the processing target pixel in parallel with the determination using the region determination section, and a selection section that selects any one of the data items processed by the first processing section, the second processing section, and the third processing section based on the determination result using the region determination section and outputs the selected data.

### SUMMARY

Incidentally, trapping is performed as image processing. The trapping refers to processing for slightly overlapping a printing target image with another printing target image such that a white outline is not generated due to a deviation at the time of forming an image.

In a case where the digital filtering is performed after the trapping is performed, since there is a difference between the processed image and an original image, image quality deteriorates.

The digital filtering refers to mathematical processing performed on a digital signal.

Aspects of non-limiting embodiments of the present disclosure relate to an image processing apparatus, an image forming apparatus, and a non-transitory computer readable medium storing a program which are capable of improving image quality compared to a case where digital filtering is performed after trapping is performed.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an image processing apparatus including a trapping section that performs trapping on a received pixel, a digital filtering section that performs digital filtering on the pixel in parallel with the trapping using the trapping section, and a selection section that selects a result of the trapping using the trapping section and a result of the digital filtering using the digital filtering section.

### BRIEF DESCRIPTION OF THE DRAWINGS

Exemplary embodiment(s) of the present invention will be described in detail based on the following figures, wherein:

FIG. 1 is a block diagram showing an image forming apparatus according to an exemplary embodiment of the present invention;

FIG. 2 is a block diagram showing a part of an image processing unit according to the exemplary embodiment of the present invention;

FIG. 3 is an explanatory diagram of a window generated by the image processing unit according to the exemplary embodiment of the present invention;

FIG. 4 is an explanatory diagram of trapping performed by the image processing unit according to the exemplary embodiment of the present invention;

FIG. 5 is a flowchart showing a data flow in the image processing unit according to the exemplary embodiment of the present invention;

FIG. 6 is a block diagram showing a part of an image processing unit according to a comparative example; and

FIG. 7 is a flowchart showing a data flow in the image processing unit according to the comparative example.

### DETAILED DESCRIPTION

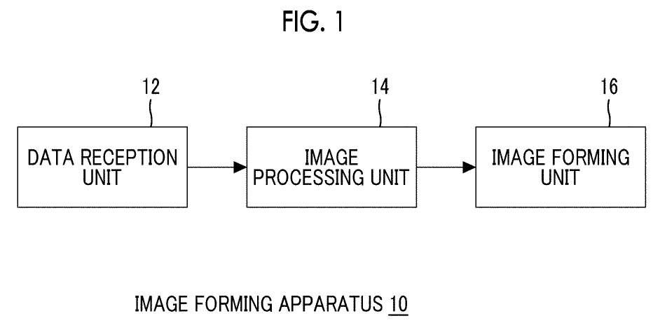

Hereinafter, exemplary embodiments of the present invention will be described in detail with reference to the drawings. FIG. 1 shows an image forming apparatus 10 according to an exemplary embodiment of the present invention. The image forming apparatus 10 includes a data reception unit 12, an image processing unit 14, and a color image forming unit 16.

The data reception unit 12 receives image data. The data reception unit receives the image data via a network, or receives an image read by an image reading device.

The image processing unit 14 processes the image data received by the data reception unit 12, and sends the processed image data to the image forming unit 16.

For example, the image forming unit 16 includes yellow (Y), magenta (M), cyan (C), and black (K) image forming units, and forms a color image obtained by superimposing YMCK images on one another by using the YMCK image forming units. The image forming unit 16 may be a xerography type or an inkjet type.

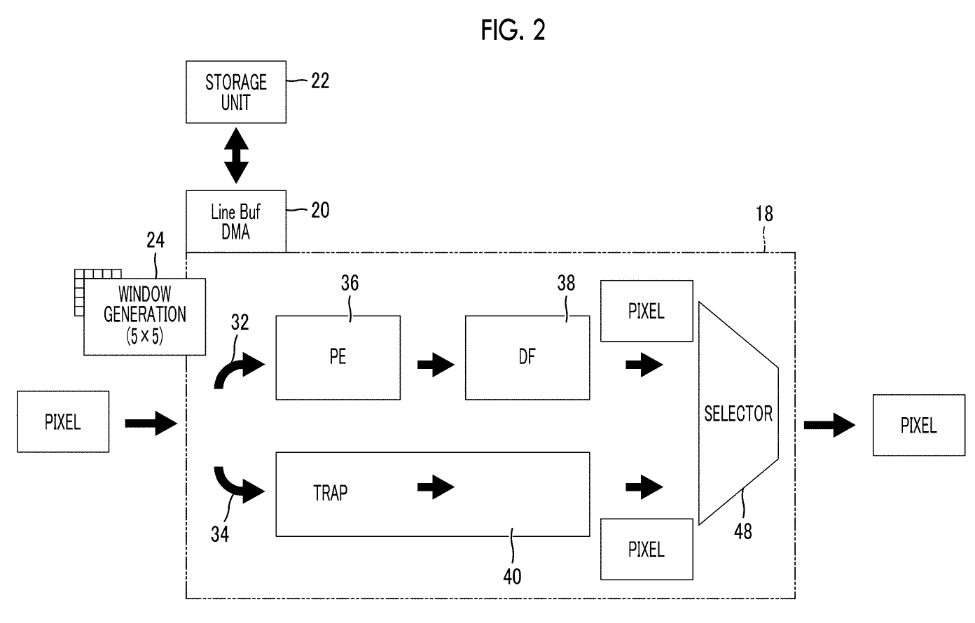

FIG. 2 is a block diagram showing a module 18 constituting a part of the image processing unit 14. For example, the module 18 is constituted by an application specific integrated circuit (ASIC).

Received pixels are transmitted to a storage unit 22 through a control unit 20. For example, the storage unit 22 is a static random access memory (SRAM, a storage element that does not require a regular data write operation for frequently reading or rewriting accumulated stored data). The storage unit 22 stores pixels for every line. The control unit 20 is a direct memory access (DMA, a type that directly transmits data). The control unit constitutes a window generation unit 24 that transmits the received data to the storage unit 22, receives pixel data from the storage unit 22, and generates a 5×5 window.

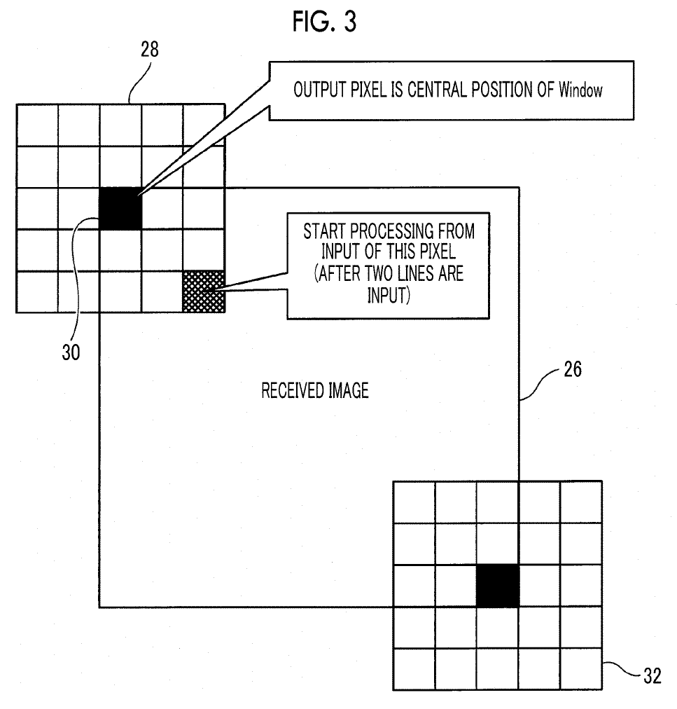

FIG. 3 is an explanatory diagram for describing a window generation method using the window generation unit 24. A received image 26 is stored in an order of receipt for every line. An initial window 28 is generated at the time of receiving a third pixel after two lines are received. That is, since an output pixel 30 is positioned in a central position of the 5×5 window, the initial window 28 is generated in a case where the output pixel 30 is positioned in an initial position of the received image 26. Generation of the initial window 28 takes as much processing time as receiving two lines.

The window is generated in a state in which it is assumed that pixels outside the received image are identical to pixels at an end of the received image. For example, on the initial window 28, it is assumed that pixels at two stages on an upper outer side of the received image 26 are upper-end pixels of the received image 26, it is assumed that pixels at two stages on a left outer side are left-end pixels of the received image 26, and it is assumed that four pixels at a diagonal outer side are upper-left-end pixels of the received image 26. The same is true of a final window 28.

Referring back to FIG. 2, the module 18 includes a digital filtering path 32 and a trapping path 34. The digital filtering path 32 includes an edge detection unit 36 and a digital filtering unit 38. The edge detection unit 36 determines whether or not the output pixel is an edge from the aforementioned window 28. The digital filtering unit 38 performs filtering by using the aforementioned window 28. For example, the digital filtering includes edge emphasis or smoothing.

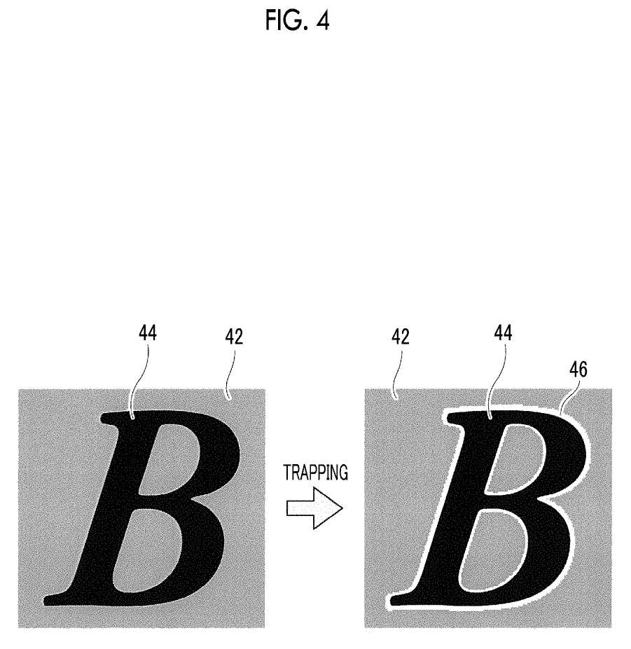

A trapping unit 40 is provided at the trapping path 34. In a case where there is an image on which a red character 44 is included in a green background 42 as shown in FIG. 4, the trapping unit 40 prevents a white outline from being generated by enlarging a boundary between the background 42 and the character 44 in order to prevent the white outline from being generated at the boundary between the background 42 and the character 44. For example, a yellow overlapped portion 46 is generated at the boundary between the background 42 and the character 44.

As stated above, since the digital filtering unit 38 and the trapping unit 40 are provided at the different paths 32 and 34, the digital filtering is performed on the pixel on which the trapping is not performed. The digital filtering is not performed after the trapping is performed, and the digital filtering and the trapping are performed in parallel.

A selector 48 constituting a selection section is configured to select the pixel on which the digital filtering is performed by the digital filtering unit 38 and the pixel on which the trapping is performed by the trapping unit 40 depending on the state of the received image.

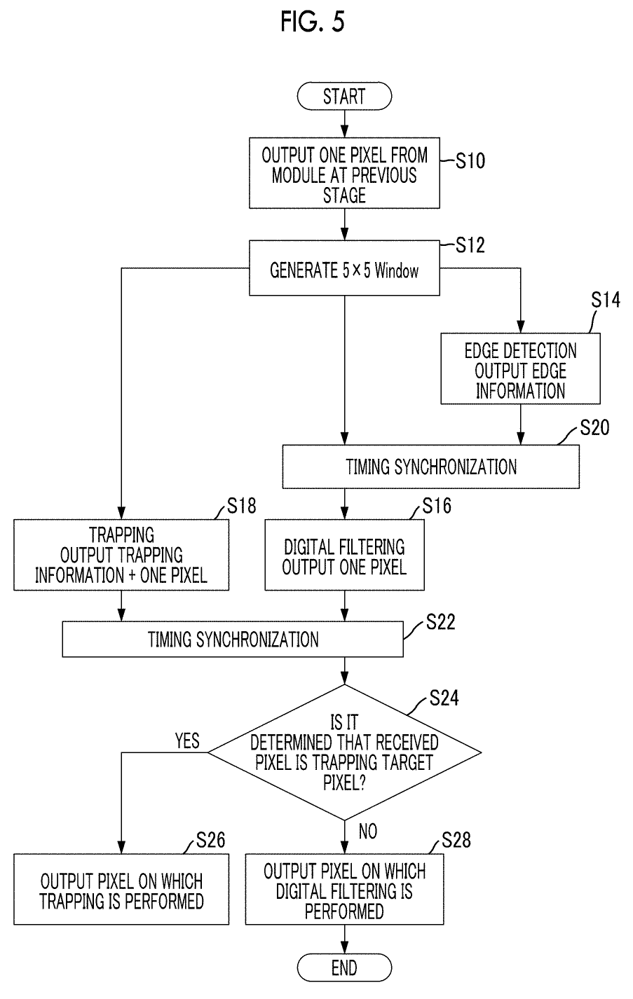

Next, a data flow in the module 18 will be described. FIG. 5 is a flowchart showing the data flow in the module.

In step S10, one pixel is initially received from the module at the previous stage. In next step S12, the 5×5 window is generated by the window generation unit 24.

The 5×5 window generated in step S12 is commonly used in the processes of steps S14, S16, and S18.

In step S14, the edge detection is performed by the edge detection unit 36, and the pixel to which edge information, that is, data indicating whether or not the output pixel is an edge is added is output.

Since the digital filtering is performed by the digital filtering unit 38 by using the 5×5 window generated in step S12 but the edge information detected in step S14 is also used in step S16, a timing when the process of step S14 is ended and a timing when the digital filtering is started are synchronized in step S20 before step S16.

In step S18, the trapping is performed by the trapping unit 40 by using the 5×5 window generated in step S12, and the pixel to which trapping information is added is output.

In step S22, the timing when the digital filtering performed in step S16 and the timing when the trapping performed in step S18 are synchronized.

In next step S24, it is determined whether or not the pixel is a trapping target pixel. In a case where it is determined that the pixel is the trapping target pixel in step S24, the process proceeds to step S26, and the pixel on which the trapping is performed is output. Thereafter, the process is ended. Meanwhile, in a case where it is determined that the pixel is not the trapping target pixel in step S24, the process proceeds to step S28, and the pixel on which the digital filtering is performed is output. Thereafter, the process is ended.

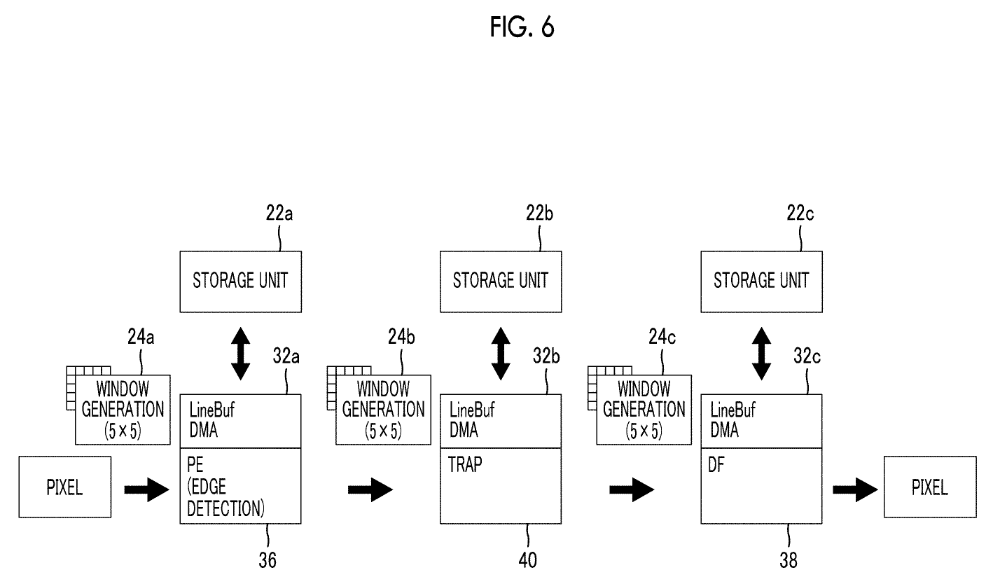

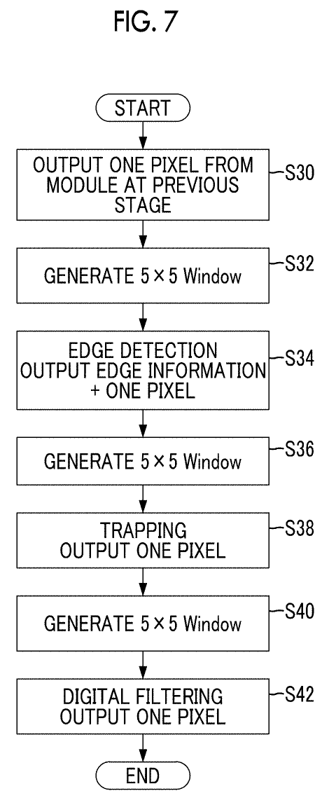

FIGS. 6 and 7 show a comparative example. In the comparative example, one pixel is initially received from the module at the previous stage in step S30.

In next step S32, a first control unit 32a generates a 5×5 window by using a first window generation unit 24a in cooperation with a first storage unit 22a.

In next step S34, the edge detection is performed by the edge detection unit 36 by using the 5×5 window generated by the first window generation unit 24a in step S32, and the pixel to which the edge information indicating whether or not the output pixel is the edge is added is output.

In next step S36, a second control unit 32b generates a 5×5 window by using a second window generation unit 24b in cooperation with a second storage unit 22b.

In next step S38, the trapping is performed by the trapping unit 40 by using the 5×5 window generated in step S36, and the processed pixel is output.

In next step S40, a third control unit 32c generates a 5×5 window by using a third window generation unit 24c in cooperation with a third storage unit 22c.

In next step S42, the digital filtering is performed by the digital filtering unit 38 by using the 5×5 window generated in step S40, and the process is ended.

By comparison of the exemplary embodiment with the comparative example, the trapping and the digital filtering are exclusively performed in parallel in the exemplary embodiment, whereas the edge detection, the trapping, and the digital filtering are performed in order in the comparative example. In the comparative example, in a case where the overlapped portion 46 shown in FIG. 4 is detected as the edge, the digital filtering is performed on the overlapped portion 46 in some cases. Thus, the digital filtering is performed on an original image in the exemplary embodiment, whereas the digital filtering is performed on an image which is obtained by performing the trapping and is distinguished from the original image in the comparative example.

The window commonly used in the edge detection, the digital filtering, and the trapping is generated in the exemplary embodiment, whereas the windows individually used in the edge detection, the digital filtering, and the trapping are generated in the comparative example. Accordingly, the generation of the window takes as much delay time as receiving two lines in the exemplary embodiment, whereas the generation of the window takes as much delay time as receiving six lines in the comparative example.

The window is generated by one control unit 20 and one storage unit 22 in the exemplary embodiment, whereas the windows are generated by three control units 20a to 20c and three storage units 22a to 22c in the comparative example. Accordingly, the area of the circuit, the number or storage capacity of storage units, and an available bandwidth are further reduced in the exemplary embodiment. The available bandwidth is a bandwidth to be used in communications. In a case where pipeline processing is performed in order to generate the windows, an available bandwidth which is three times the available bandwidth in the exemplary embodiment is needed in the comparative example.

Although it has been described in the exemplary embodiment that the image processing apparatus is constituted by the hardware, the image processing apparatus may be realized by software. In this case, the number of steps is reduced instead of the circuit scale.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a trapping section that performs trapping on a received pixel;
a digital filtering section that performs digital filtering on the pixel in parallel with the trapping using the trapping section; and
a selection section that selects a result of the trapping using the trapping section and a result of the digital filtering using the digital filtering section.

2. The image processing apparatus according to claim 1,
wherein the digital filtering section performs the digital filtering on the pixel that is not processed by the trapping section.

3. The image processing apparatus according to claim 2,
wherein the digital filtering section does not process the pixel that is processed by the trapping section.

4. The image processing apparatus according to claim 1,
wherein the trapping section and the digital filtering section respectively perform the trapping and the digital filtering through different paths.

5. The image processing apparatus according to claim 4,
wherein the trapping section performs the trapping through a trapping path.

6. The image processing apparatus according to claim 4,
wherein the digital filtering section performs the digital filtering through a digital filtering path.

7. The image processing apparatus according to claim 1, further comprising:
a window generation section that generates a window as an inspection frame constituted by a set of pixels which is commonly used in the trapping section and the digital filtering section.

8. The image processing apparatus according to claim 2, further comprising:
a window generation section that generates a window as an inspection frame constituted by a set of pixels which is commonly used in the trapping section and the digital filtering section.

9. The image processing apparatus according to claim 3, further comprising:
a window generation section that generates a window as an inspection frame constituted by a set of pixels which is commonly used in the trapping section and the digital filtering section.

10. The image processing apparatus according to claim 4, further comprising:
a window generation section that generates a window as an inspection frame constituted by a set of pixels which is commonly used in the trapping section and the digital filtering section.

11. The image processing apparatus according to claim 5, further comprising:
a window generation section that generates a window as an inspection frame constituted by a set of pixels which is commonly used in the trapping section and the digital filtering section.

12. The image processing apparatus according to claim 6, further comprising:
a window generation section that generates a window as an inspection frame constituted by a set of pixels which is commonly used in the trapping section and the digital filtering section.

13. The image processing apparatus according to claim 7, further comprising:
a storage section that stores a received image,
wherein the window generation section generates the window by using pixels stored in the storage section.

14. The image processing apparatus according to claim 8, further comprising:
a storage section that stores a received image,
wherein the window generation section generates the window by using pixels stored in the storage section.

15. The image processing apparatus according to claim 9, further comprising:
a storage section that stores a received image,
wherein the window generation section generates the window by using pixels stored in the storage section.

16. The image processing apparatus according to claim 10, further comprising:
a storage section that stores a received image,
wherein the window generation section generates the window by using pixels stored in the storage section.

17. The image processing apparatus according to claim 11, further comprising:
a storage section that stores a received image,
wherein the window generation section generates the window by using pixels stored in the storage section.

18. The image processing apparatus according to claim 12, further comprising:
a storage section that stores a received image,
wherein the window generation section generates the window by using pixels stored in the storage section.

19. An image forming apparatus comprising:
an image forming unit that forms a color image; and
an image processing unit that processes the image for the image forming unit,
wherein the image processing unit includes
a trapping section that performs trapping on a received pixel,
a digital filtering section that performs digital filtering on the pixel in parallel with the trapping using the trapping section, and
a selection section that selects a result of the trapping using the trapping section and a result of the digital filtering using the digital filtering section.

20. A non-transitory computer readable medium storing a program causing a computer to perform:
trapping on a received pixel;
digital filtering on the pixel in parallel with the trapping; and
selecting a result of the trapping and a result of the digital filtering.
